(19) United States
(12) Patent Application Publication
(10) Pub. No.: US 2025/0163750 A1
(43) Pub. Date: May 22, 2025

(54) METAL PROFILE FOR DOOR/WINDOW FRAME STRUCTURE AND METHOD FOR MAKING SUCH PROFILE

(71) Applicant: SERRAMENTI BROMBAL S.R.L., Altivole (TV) (IT)

(72) Inventor: Pietro BROMBAL, Altivole (TV) (IT)

(21) Appl. No.: 18/833,842

(22) PCT Filed: Jan. 27, 2023
(86) PCT No.: PCT/IB2023/050729

§ 371 Date: Jul. 26, 2024

(30) Foreign Application Priority Data
Jan. 27, 2022 (IT) 102022000001406

(51) Int. Cl. E06B 3/16; E06B 3/263; E06B 3/273

(52) U.S. Cl. CPC E06B 3/16; E06B 3/26303; E06B 3/2735

(57) ABSTRACT

A metal profile (1) for door/window frame structure (S, S′) provided with a metal frame (A), an insulating element (C) and/or a linear gasket (G) arranged inside said frame (A). The profile (1) comprises an elongated body (6) that extends along a longitudinal extension direction (L), a first end portion (8) and a second end portion (9) of the elongated body (6). The first end portion (8) of the body (6) is suited to interact with the frame (A) and/or the linear gasket (G) of the door/window frame structure (S, S′) and the second end portion (9) of the body (6) is suited to be coupled with the insulating body (C) of the door/window frame structure (S, S′) to promote its holding with respect to a substantially transverse direction (T) and form a unitary assembly with it. A method for making a metal profile (1) for door/window frame structure (S, S′).

### FIELD OF APPLICATION OF THE INVENTION

The present invention concerns the technical field of door/window frame and doors/windows casing, and the subject of the invention is a metal profile for door/window frame structures.

The invention also relates to a method for making the present metal profile for

door/window frame structures.

### STATE OF THE ART

As is known, the door/window frame structures used in the technical field of (doors and/or windows) casing require the use of a pair of frames, the first of which is intended to be anchored to a wall of the building in a stable manner while the second is movable with respect to the first so that it can be selectively coupled with the latter.

The techniques for making door/window frame structures have evolved continuously over time, to the point that today various types of door/window frames are available on the market and each of them has its own specific characteristics.

A first configuration of a door/window frame involves the use of a metal frame obtained from conveniently shaped pieces of profile.

These pieces of metal profile define both parts of the door/window casing (the fixed portion and the movable portion) and their cross-sectional shape is selected in such a way as to promote the creation of walls and surfaces suited to allow the frame to be anchored to the wall of the building and at the same time a glass pane or a door panel to be supported.

The metal profiles used to make these door/window frame structures are generally obtained by means of a drawing process, using molds that are shaped according to the specifications provided by the manufacturer of the door/window casing.

It is common to use an insulating element suited to promote thermal insulation between the internal and the external environment with respect to the door/window casing.

In particular, the insulating elements serve the function of defining a “thermal break” between the two parts of the structure.

The insulating elements are generally made of polymeric material and are interposed between the inner walls of the frame that are obtained using the metal profile.

A second type of door/window frame involves the use of frames obtained from metal profiles consisting of pieces of linear metal sheet conveniently bended so that to have a predetermined cross-sectional shape.

In this case, therefore, the metal profiles are not of the extruded type but are obtained through a bending and flanging step (carried out with bending and flanging machines), through which the profile can be given a predetermined shape and mechanical strength.

In general, the bent and shaped profile has an end suited to hold the insulating element, for example it is possible to provide an open end of the profile, inside which the end portion of the insulating element is inserted.

The insulating element can be locked onto the metal profile by interference or by making an edge at specific areas of the profile.

A further type of door/window frame involves the use of structures having substantially rectangular or square frames obtained from flat metal profile.

The insulating element is connected to said structures by means of a plurality of retaining pins distributed along the extension of the frame.

The technical solutions described above have some drawbacks, first of all the reduced flexibility in the use of each type of casing.

The current door/window frame configurations in fact, do not allow for easy adaptation to all possible design conditions, and for this reason the adaptation of the casing to the particular installation environment often involves non-negligible effort and time.

A further drawback of the solutions described above is their high complexity of implementation, which requires the fabrication and assembly of a large number of components.

Another drawback associated with these door/window frame structures is the high precision required for the manufacture of each individual component and necessary to enable the correct installation of the casing.

Still, not the least drawback of these solutions is the relatively high construction and labour costs associated with such frame structures. Documents EP 3 626 927 and IT102015000029272 describe door/window frame structures comprising a profile intended to be coupled with an insulating element. However, the profiles described in these documents also have the same drawbacks as outlined above.

### PRESENTATION OF THE INVENTION

The present invention intends to overcome the technical drawbacks described above by providing a particularly efficient and high-performance profile for door/window frame structures.

More specifically, the main object of the present invention is to provide a profile for door/window frame structure that is particularly flexible in use and can easily adapted to any installation conditions.

A further scope of the present invention is to provide a profile for door/window frame structure that is particularly resistant and durable as well as capable of maintaining its thermal and acoustic insulation properties unaltered over time.

A further purpose of the present invention is to make available a profile for door/window frame structures that minimises the demand for maintenance activities expected after its installation.

A further purpose of the present invention is to make available a profile for door/window frame structures whose construction is particularly simple and consisting of a single piece.

A further purpose of the present invention is to provide a profile for door/window frame structure that is particularly versatile in use and can thus be used to make a high number of door/window casings.

Another object of the present invention is to provide a profile for door/window frame structures that has significantly low production and installation costs.

These objects, together with others that are better clarified below, are achieved by a profile for door/window frame structures according to claim 1.

Other objects that are better described below are achieved by a profile for door/window frame structures according to the dependent claims.

According to a further aspect of the present invention, a method is provided for making a profile for door/window frame of the type in accordance with claim 11.

### BRIEF DESCRIPTION OF THE DRAWINGS

The advantages and characteristics of the present invention clearly emerge from the following detailed description of some preferred but non-limiting configurations of a door/window frame structures with particular reference to the following drawings:

FIG. 1A and FIG. 1B are cross-sectional views of door/window casing made with a pair of frames structures containing the profile that is the subject of the present invention;

FIG. 2A and FIG. 2B are side sections of a part used in the door/window frame structures illustrated in FIG. 1A and FIG. 1B;

FIGS. from 3A to 5B are respective cross-sectional views of a metal profile subject of the present invention in different configurations;

FIG. 6 is a schematic perspective representation of a piece of metal sheet used to produce the profile object of the present invention.

### DETAILED DESCRIPTION OF THE INVENTION

The subject of the present invention is a metal profile for door/window frame structures. This profile, hereinafter referred to by the reference number 1, may be predominantly used for making structures suited to define a door/window casing and or a door.

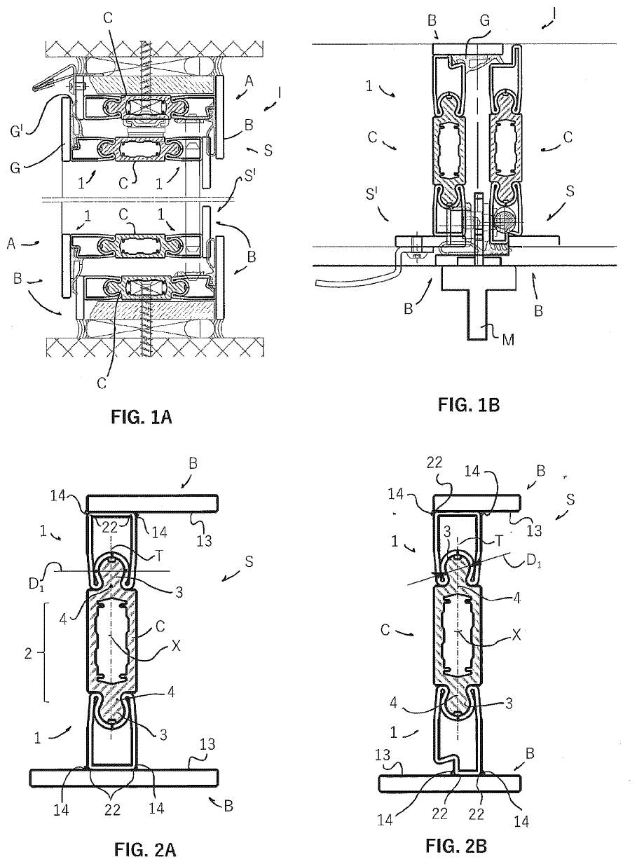

FIG. 1A and FIG. 1B illustrate two respective configurations (among many possible) of a window casing I installed in a masonry work made using the metal profile 1 object of the present invention.

The door/window casing I in FIG. 1A is a single wing window whose opening faces outwards.

The door/window casing in FIG. 1B, on the other hand, represents the central part of a double wing window whose opening faces outwards.

The door/window casing illustrated in FIG. 1A has a pair of mutually coupled frame structures S, S′.

There is in fact an external door/window frame structure S, intended to be permanently anchored to the bearing wall of the masonry work, and an internal frame structure S′ suited to be hinged to the external structure S so as to define the movable wing of the door/window casing.

Both structures S, S′ comprise a metal frame A consisting of a pair of flat metal profiles B suited to define the end walls of the structure S, S′, and an insulating element C interposed between the pair of flat profiles B.

The insulating element C may consist of a piece of drawn polymer material having properties that ensure high thermal insulation.

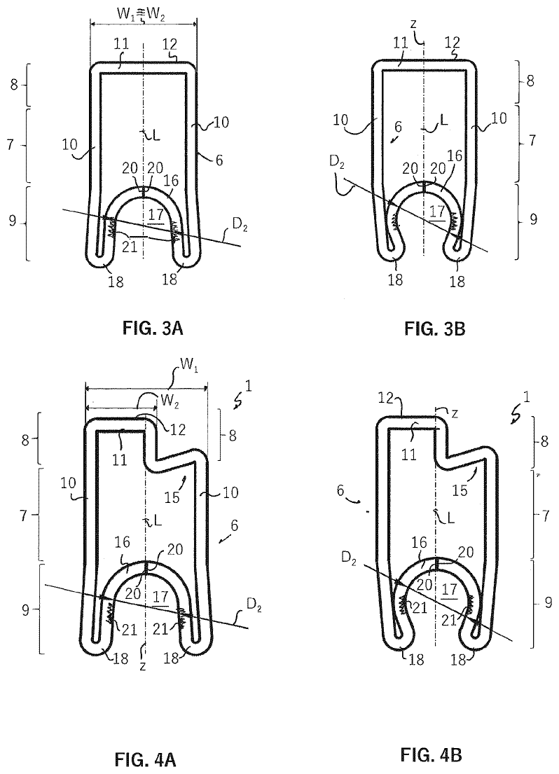

The insulating element C is also illustrated in FIGS. 2A and 2B.

The door/window casing I illustrated in FIG. 1B also has a pair of door/window frame structures S, S′ of the type described above, with one of such structure S being associated with a handle for opening the wing.

Again, each door/window frame structure S,S′ comprises, respectively, a metal frame A consisting of a pair of flat profiles B and an insulating element C interposed between the pair of flat profiles B.

In both door/window casings I schematized in FIGS. 1A and 1B, a linear gasket G is visible which is intended to interact with the frames A of the door/window frame structure S, S′.

The interaction of the linear gasket G with the surfaces of the metal frame A prevents water or condensation on the outside of the masonry work from infiltrating the inside of the door/window casing I.

The linear gasket G may be of various types, for example it may have a lip seal G′ intended to interact with the flat profiles B of the frame A to define, in cooperation with them, a seal to liquids.

Alternatively, the linear gasket G may be of the “balloon” type, that is it may have a peripheral wall suited to delimit an air-filled cavity. This type of gasket can be seen in FIG. 1A with the reference letter G″.

Conveniently, the insulating element C may extend mainly along a longitudinal extension direction, indicated in the Figures by the reference letter X.

In particular, the longitudinal direction X of the elongated element C is incoming with respect to the plane on which the Figures lie.

The insulating element C has two portions extending along the transverse direction indicated in the Figures by the reference letter T: a central portion 2 having a substantially polygonal shape, and a pair of ends 3 arranged on the opposite side with respect to the central portion 2.

The central portion 2 of the insulating element C may have a substantially rectangular cross-sectional shape.

Furthermore, the insulating element C may have shaped transverse ends 3.

In the door/window frame structure illustrated in FIG. 1 and in the cross-sectional views of FIG. 2A and FIG. 2B, the ends 3 of the insulating element C have a substantially semi-circular cross-sectional shape.

In fact, it has been found experimentally that an insulating element C provided with ends 3 having a circular or semicircular cross-sectional shape makes it possible to reach a good technical compromise in terms of mechanical rigidity and ease of coupling with the other components of the structure.

As will be better described below, in fact, the end of the insulating element is coupled with the metal profile that is the subject of the present invention so as to obtain a unitary component.

A semicircular design of the ends respectively associated with the insulating element and the profile facilitates the coupling operations between these elements while providing high mechanical resistance to the unitary assembly obtained as a result of such coupling.

It is also possible to define a connecting area 4 suited to connect the end 3 of the insulating element C to the central portion 2 thereof.

In the case illustrated in the Figures, the connecting portion 4 is shaped in such a way as to define a tapered neck 5 that has a reduced dimension with respect to the diameter D₁ of the end itself.

As better illustrated in FIG. 1, the insulating element C may be arranged in the region of the space separating the two flat profiles B; in this way, this component may promote thermal insulation between the profile B in contact with the environment outside the masonry work, and the profile B in contact with the environment inside the masonry work.

As will be better described below in the present description, the metal profile 1 subject of the invention can be used in the door/window frame structure S, S′ illustrated in FIG. 1A and FIG. 1B (or in a similar door/window frame structure) to join in a stable manner the flat profiles B with the insulating element C.

In other words, the function of the metal profile 1 subject of the invention is to connect the flat profiles B defining the end walls of the frame A with the insulating element C interposed therebetween.

The use of metal profile 1 will therefore allow a unitary door/window frame structure S, S′ consisting of a pair of flat profiles B, the profile itself and a polymeric insulating element C.

The metal profile 1 for door/window frame structures comprises an elongated body 6 extending along a substantially longitudinal extension direction.

In the Figures, the extension direction of the body 6 is indicated by the reference letter L and is incoming with respect to the plane on which the Figures lie.

At such a body 6, it is possible to define a central portion 1, a first end portion 8 and a second end portion 9.

With respect to the central portion of body 6, the two end portions 8, 9 are placed on opposite sides along a substantially transverse direction indicated in the Figures by the reference letter Z.

In this case, the transverse direction Z lies in the same plane as the Figures.

As better illustrated in FIGS. from 3A to 5B, the central portion 7 of the metal body 6 may be defined by a pair of side walls 10 substantially longitudinal and parallel to each other.

These two walls 10 are also spaced with a predetermined distance and said distance is also suited to define the width w₁ of both the body 6 and the profile 1, respectively.

Conveniently, the first end portion 8 is configured to be stably anchored to the frame A of the door/window frame structure S, S′.

According to the configuration of the metal profile 1 illustrated in Figures from 3A to 5A, the first end portion 8 may comprise a substantially transverse wall 11.

This transverse wall 11 has an external surface 12 suited to come into contact with the frame A of the door/window frame structure S, S′ and/or with a linear gasket G associated with the frame A itself.

The case in which the transverse wall 11 of the first end 8 of the body 6 is configured to come into contact with the inner surface 13 of the flat profiles B is illustrated in FIG. 2A, FIG. 2B, FIG. 3A, FIG. 3B, FIG. 4A and FIG. 4B.

These profile configurations 1 provide that the outer surface 12 of the transverse wall 11 comes into contact with the inner surface 13 of the flat profiles B that make up the frame A.

As will be better described later in the present description, the transverse wall 11 may be anchored to the flat profile B by suitable connecting means.

For example, the connecting means could be weld beads 14 suited for mutually joining the metal profile 1 with the flat profile B.

Conveniently, the transverse wall 11 intended to come into contact with the frame A of the door/window frame structure S,S′ may have a predetermined width w₂ substantially equal to the width w₁ of the body 6.

In this case, therefore, the first end portion 8 of the body 6 has a transverse wall 11 extending across the entire width w₁ of the body itself so as to have a maximum contact extension with the inner surface 13 of the respective metal profile A.

The contact area between the two surfaces (the outer surface 12 of the transverse wall 11 and the inner surface 13 of the flat profile B defining the frame A) is therefore, the maximum possible, being in fact extended over the entire width w₁ of profile 1.

This configuration of the transverse wall 11 of the body 6 is clearly visible in FIG. 2A, FIG. 2B, FIG. 3A and FIG. 3B.

However, the transverse wall 11 associated with the first end portion 8 may have a width w₂ smaller than the overall width w₁ of the body 6.

In this case, therefore, the area of contact between the two surfaces (the outer surface 12 of the transverse wall 11 and the inner surface 13 of the flat profile B defining the frame A) is partial, that is it does not extend over the entire width w₁ of the profile 1.

This configuration of the transverse wall 11 of the body 6 is clearly visible in the FIGS. 2A and 2B and in FIGS. from 4A to 5B.

In this type of profiles 1, the first end portion 8 also includes a shaped section 15 positioned flanking the end wall 11.

The shaped section 15 may, for example, define an undercut whose function is to house and hold the linear gasket G intended to interact with the frame A of the door/window frame structure S, S′.

The case where the transverse wall 11 of the first end portion 8 of the body 6 is configured to come into contact with the linear gasket G is illustrated in FIG. 1A, FIG. 5A and FIG. 5B.

In this case, as can best be seen in FIGS. 5A and 5B, the first end portion 8 has a substantially “U”-shaped wall 15 that joins the transverse wall 11 defining a flat step.

The transverse wall 11 is therefore in a lowered position with respect to the “U”-shaped wall 15 and its outer surface 12 is intended to come into contact the lip G′ of the linear gasket G, as best seen in FIG. 1A.

Conveniently, the second end portion 9 of the body 6 of the metal profile 1 is intended to interact with the insulating element C of the door/window frame structure S, S′.

In particular, the second end portion 9 will be suited to promote the holding of the insulating element C along the transverse direction indicated in the figures by the reference letter T.

The second end portion 9 will then promote the anchorage of the body 6 (and therefore of the profile 1) to the insulating element C so as to form with the latter a unitary assembly.

The anchoring of the profile 1 to the insulating element C to form a unitary assembly is clearly visible in FIGS. from 1A to 2B.

Preferably, the second end portion 9 may comprise a shaped wall 16 defining a seat 17 within which it is possible to partially insert the ends 3 of the insulating element C of the frame structure A.

In the configuration of the profile 1 illustrated in the Figures, the seat 17 defined by the second end portion is configured to house and hold the shaped ends 3 of the insulating element C.

The seat 17 formed on the second end portion 9 makes it possible the coupling of the body 6 with the ends 3 of the insulating element C, to promote this coupling it is necessary to insert the end 3 of the latter inside the housing defined by the seat 17.

For this reason, the shaped wall 16 of the body 6 will be suited to define a seat 17 whose cross-sectional shape is substantially complementary to the cross-sectional shape of the end of the insulating element C.

In particular, the seat 17 may have a substantially semi-circular cross-sectional shape.

This configuration is clearly visible in all Figures and, in particular, in the FIGS. from 3A to 5B.

As described above, the choice of a semicircular shape for both the end 6 of the insulating element 4 and the seat 17 formed on the first end 16 of profile 13 has the respective advantages: i) it allows for easy coupling of the two components (the semicircular shape facilitates the sliding and/or the insertion of the end 6 of the insulating element into the seat 17), ii) it maintains the mechanical resistance of this coupling high.

Preferably, the seat 17 is of such dimensions as to allow the entire housing of the end 3 of the insulating element C.

In particular, as best seen in FIGS. 2A, 3A, 4A and 5A, the body 6 of the profile 1 may have originally a seat 17 having a substantially “U” shape delimited by a pair of substantially parallel end edges 18 spaced apart with a distance d₁, not less than the diameter D₂ of the semicircular part of the seat 17.

In this way, il will be particularly easy to insert the shaped end 3 of the insulating element C within the seat 17.

Following the insertion of the end 3 inside the seat 17, the end edges 18 of the latter may be brought closer to each other.

For example, said edges 18 may be brought closer to each other through the action of an flanging machine.

The approaching of the edges 18 promotes a change in the shape of the seat 17 and such that the latter is coupled to the shape of, respectively, the end 3 and the connecting area 4 of the insulating element C.

The edges 18 of the seat 17 will then be brought closer so as to bring them to a distance d₂ smaller than the diameter D₁ of the end 3 of the insulating element C.

This condition is clearly visible in FIGS. 2B, 3B, 4B and 5B.

In this way, the end 3 of the insulating element C will no longer be able to protrude from the seat 17 so as to promote the stable holding of said element C with the metal profile 1 in order to obtain, by means of this connection, a unitary assembly.

In the configuration of the invention illustrated in the Figures, it is provided the use of two respective metal profiles 1 suited to promote the holding of both the ends of the insulating element C.

Thus, in this case, the unitary assembly consists of a pair of profiles 1 and a single insulating element C coupled to such profiles 1 at its ends 3.

Conveniently, the development of the seat 17 suited to define the second portion of the end 9 of the body 6 may extend inwards into the body itself.

As is well illustrated in the Figures, in fact, the body 6 may be internally hollow and the seat 17, defining the extension of the second end portion 9, develops internally to the inner part of such profile 1.

In particular, the profile 1 and the body 6 may include a pair of end edges 20 mutually joined or joined together so as to define a substantially closed and internally hollow cross-section.

The closed cross-section of the body 6 makes it possible to increase the overall mechanical rigidity of the profile 1, giving it a shape including end portions 3, 9 that can be easily coupled with the frame A and/or the gasket G of the structure S, S′, and with the insulating element C.

A profile 1 and a hollow body 6 having a substantially closed cross-section can be formed from a piece of metal sheet 19 comprising respective end edges 20.

The piece of metal sheet 19 undergoes a bending suited to bring into contact or to join the edges 20; in this way, it is possible to define a closed and internally hollow body 6 of the type illustrated in the Figures.

The definition of a second end portion 9 extending inward from body 6 (predominantly along the transverse direction Z) has the advantage of keeping the overall length I₁ of the body 6 and the profile 1 small.

Advantageously, in correspondence with the inner surface of the shaped wall 16 defining the seat 17, knurls 21 can be obtained whose purpose is to increase the interaction generated between the seat itself and the end 3 of the insulating element C.

Knurls 21 can be considered as a technical means suited to promote the holding of the body 6 of the profile 1 to insulating element C.

Knurls 21 can be seen in profile 1 illustrated in FIGS. from 3A to 5B.

In addition, knurls 21 may affect the entire extension of the surface of the inner wall 16 that delimits the seat 17, or only a limited part of that wall.

For example, in the wall 16, there may be several areas in which the knurls 2 are formed, said areas may be spaced apart by sections of smooth surface and may extend over the entire extension of the body 6 of the profile 1.

According to a further aspect of the invention, there is provided a method for making a metal profile 1 intended to be used in door/window frame structures A of the type described above.

This method involves a first step of a) of providing a flat piece of metal sheet 19.

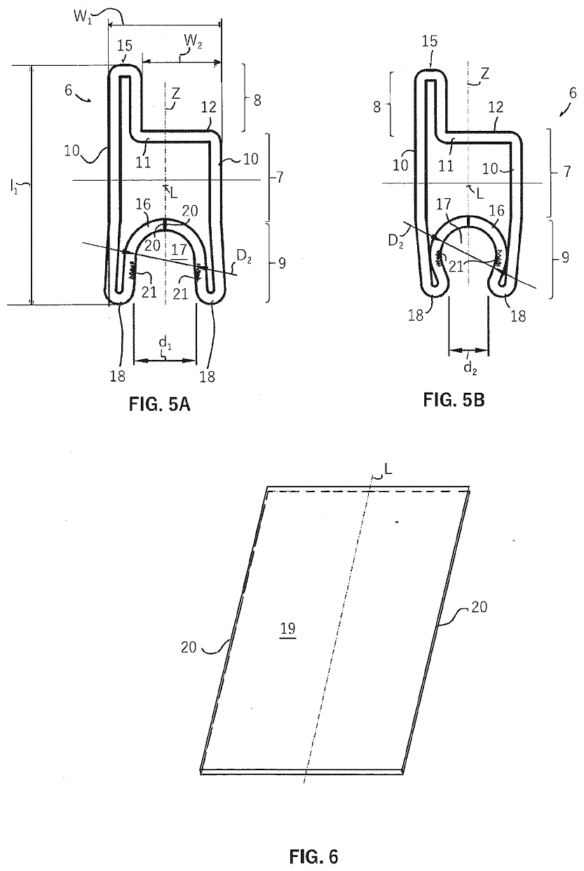

The piece of metal sheet 19 provided in step a) is schematically illustrated in FIG. 6; said piece of metal sheet 19, moreover, extends along a longitudinal extension direction L and has a pair of substantially straight end edges 20.

There is also provided a step b) of bending the piece of metal sheet 19 according to predetermined bending lines.

In particular, during step b) the piece of metal sheet 19 may be bent so as to obtain a metal profile extending along a longitudinal extension direction L substantially parallel to or coinciding with the extension direction of the initial piece of metal sheet 19.

When all the folds have been made, there is a step c) of the method in which the joining of end edges 20 of the previously bended metal sheet 19 is promoted.

What is obtained at the end of step c) is an internally hollow metal profile with a closed cross-section.

According to a peculiar aspect of the method, the metal profile obtained following the execution of steps from a) to c) may be of the type already described above and better illustrated in FIGS. from 1A to 5B.

This method, therefore, will result in a profile 1 provided with: i) a first end portion 8 intended to interact with the frame A and/or the linear gasket of the door/window frame structure S. S′, ii) a second end portion 9 suited to interact with the insulating element C of the door/window frame structure A to promote the holding of the element C with respect to a substantially transverse direction Z and to form a unitary assembly with the same element.

The step b) of the method may be carried out in such a manner as to promote the construction of a body 6 provided with a pair of side walls 10 substantially longitudinal and parallel to each other.

These walls 10 may be spaced so as to define a predetermined width w₁ for the body 6 and profile 1.

During the execution of the bending step b), a substantially transverse wall 11 formed at the first end portion 8 of the body 1 may also be provided.

The transverse wall 11 may have an outer surface 12 intended to interact with the frame A and/or the linear gasket G present in the door/window frame structure S, S′.

Also during the execution of the bending step b), a second end portion 9 of the body 6 may be provided, which is provided with a shaped wall 16 suited to define a seat 17 for (at least partial) housing of the insulating element C.

In particular, the seat 17 will be suited for housing and holding one end 3 of the insulating element C.

As better visible in the profiles 1 illustrated in the Figures, during the execution of step c) the end edges 20 of the metal sheet 19 may be mutually coupled (that is mutually joined) in an area defining the second end portion 9.

In particular, the two edges 20 of the metal sheet 19 may be brought together in correspondence of the shaped wall 16 that defines the seat 17 for housing the end 3 of the insulating element C.

As can best be seen in FIGS. from 1A to 5B, the seat 17 may be formed by the joining of two half-seats, each of which is formed using the end area of the metal sheet 19 that is close to the respective edge 20.

The closure of the seat 17 is obtained by the approaching (and the corresponding frontal coupling) of the two edges 20 of the metal sheet 19.

The method may also comprise a step d) during which one or more knurls 21 are made at the wall 16 of the profile suited to define the seat 17.

The step d) may be performed on the piece of metal sheet before it undergoes the bending step b).

Alternatively, the step d) may be performed after step b) and/or step c), through the use of special knurling machines capable of knurling inside seats or cavities.

According to a further aspect in the present invention, it is provided a method for producing a door/window frame structure S, S′ comprising the profile 1 described above.

The door/window frame structure S, S′ obtainable with this method is illustrated in the FIGS. 2A and 2B

Firstly, said method comprises the steps from a) to c), which are described above, and suited to obtain a pair of elongated profiles 1 each having a first end portion 8 and a second end portion 9.

A coupling step d) is then provided between the second end portion 9 of two respective profiles 1 and the end portion 3 of the insulating element C so as to obtain a unitary assembly consisting of a single polymeric insulating element C and two respective metal profiles 1.

Thereafter, the method comprises a step e) of coupling the first end portion 8 of each profile 1 with a flat metal profile B.

In particular, the step e) may comprise two respective sub-steps: a sub-step e′) in which the outer surface 12 of the transverse wall 11 of profile 1 is in contact with the inner surface 13 of the flat profile B, and a second sub-stage e″) in which a plurality of weld beads 14 are suited to join in a stable manner the profile 1 to the respective flat profile B.

Conveniently, sub-step e″) may be performed by means of a laser welding performed essentially in a cold state.

In particular, the transverse wall 11 of the profile 1 may have a radiused at the edges such as to generate a pair of substantially parallel grooves 22 when the metal profile B is placed on the same wall 11.

Advantageously, the formation of a pair of continuous weld beads 14 at both of these grooves 22 will be promoted during the execution of the sub-step e″).

Conveniently, the weld beads 14 may be continuous and extend along the entire length of these grooves 22 (that is, the entire length of the body 6).

The present invention can be carried out in other variants, all falling within the scope of the inventive features claimed and described herein; said technical features can be replaced by different technically equivalent elements and materials; the shapes and dimensions of the invention can be any as long as they are compatible with its use.

The reference numbers and signs included in the claims and in the description are only intended to make the text clearer to understand and must not be considered as elements limiting the technical interpretation of the objects or processes identified by them.

1. A metal profile (1) for door/window frame structures (S, S′), wherein the frame structure comprises a metal frame (A) and/or an insulating element (C) and/or a linear gasket (G) arranged inside said frame (A), said metal profile comprising:
an elongated body (6) extending along a substantially longitudinal extension direction (L);
a first end portion (8) of said elongated body (6);
a second end portion (9) of said elongated body (6);
wherein said first end portion (8) of said body (6) is suited to interact with the frame (A) and/or with the linear gasket (G) of the door/window frame structure (S, S′);
wherein said second end portion (9) of said body is suited to be coupled with said insulating element (C) of the door/window frame structure (S, S′) to hold thereof with respect to a substantially transverse direction (T) and form a unitary assembly with said insulating element (C);
and wherein said metal profile (1) is formed by a piece of bent metal sheet (19) with a pair of end edges (20), said end edges (20) of the piece of sheet metal (19) being reciprocally joined to each other to define a closed and internally hollow elongated body (6).

2. Profile according to claim 1, characterized in that said elongated body (6) comprises a pair of side walls (10) substantially longitudinal and parallel to each other, said side walls (10) being transversally spaced so as to define a predetermined width (w₁) for said body (6).

3. Profile according to claim 2, characterized in that said first end portion (8) comprises a substantially transverse wall (11) suited to come into contact with the frame (A) of the door/window frame structure (S, S′).

4. Profile according to claim 3, characterized in that said transverse wall (11) of said first end portion (8) has a predetermined width (w₂) substantially equal to the width (w₁) of said body (6).

5. Profile according to claim 3, characterized in that said transverse wall (11) of said first end portion (8) has a width (w₂) smaller than the width (w₁) of said body (6).

6. Profile according to claim 5, characterized in that said first end portion (8) has a shaped section (15) having a predetermined shape, said shaped section (15) being joined to said flat transverse wall (11).

7. Profile according to claim 1, characterized in that said second end portion (9) of said body (6) comprises a shaped wall (16) suited to define a seat (17) for at least partial housing of the insulation element (C) of the door/window frame structure (S, S′).

8. Profile according to claim 7, characterized in that the wall (16) of said second end portion (9) of said body (6) is shaped so as to define a seat (17) having a substantially semicircular cross-sectional shape.

9. Profile according to claim 7, characterized in that, with respect to a substantially transverse direction (T) passing through said first (8) and said second end portion (9) of said body (6), said seat (17) extends inwards of said body (6).

10. Profile according to claim 1, characterized in that said body (6) is internally hollow.

11. Method for making a metal profile (1) of the type according to claim 1 suited to be used in the door/window frame structure (S, S′), wherein the door/window frame structure (S, S′) comprises a metal frame (A) and an insulating element (C) and/or a linear gasket (G) arranged inside said frame (A), said method comprising the following steps:
a) providing of a piece of flat metal sheet (19) having predetermined dimensions and a pair of end edges (20);
b) bending of said piece of metal sheet (19) along predetermined bending lines so as to obtain an elongated metal profile (1) extending along a longitudinal extension direction (L), said metal profile having a body (6) with a first end portion (8) and a second end portion (9);
c) joining of said end edges (20) of said bent metal sheet (20) to define a closed and internally hollow body (6);
wherein said first end portion (8) is suited to interact with the frame (A) and/or the linear gasket (G) of the door/window frame structure (S, S′);
and wherein said second end portion (9) is suited to interact with the insulating element (C) of the door/window frame structure (S, S′) to hold thereof with respect to a substantially transverse direction (T) and to form a unitary assembly with said insulating element (C).

12. Method according to claim 11, characterized in that, in said bending step b) the formation of a pair of side walls (10) substantially longitudinal and parallel to each other is provided, said side walls (10) being transversely spaced apart to define a predetermined width (w₁) for said body (6).

13. Method according to claim 11, characterized in that in said bending step b), the formation of a first end portion (8) having a substantially transverse wall (11) suited to interact with the frame (A) and/or with the linear gasket (G) of the door/window frame structure (S, S′) is provided.

14. Method according to claim 11, characterized in that in said bending step b), a second end portion (9) provided with a shaped wall (16) suited to define a longitudinal seat (17) for housing at least one end (3) of the insulating element (C) of the door/window frame structure (S, S′) is provided.

15. Method according to claim 14, characterized in that in said step c), the end edges (18) of said bent metal sheet (20) are in contact with each other, said edges (18) being placed at said shaped wall of said longitudinal seat (17).
